(19) United States
(12) Patent Application Publication
(10) Pub. No.: US 2022/0070948 A1
(43) Pub. Date: Mar. 3, 2022

(54) COMMUNICATION DEVICE, COMMUNICATION METHOD, AND COMPUTER PROGRAM PRODUCT

(71) Applicant: JVCKENWOOD Corporation, Yokohama-shi (JP)

(72) Inventors: Yasuma Suzuki, Yokohama-shi (JP); Kazuki Takamiya, Yokohama-shi (JP); Hiroyuki Nakajima, Yokohama-shi (JP); Emi Tomiyasu, Yokohama-shi (JP)

(21) Appl. No.: 17/401,399

(22) Filed: Aug. 13, 2021

(30) Foreign Application Priority Data
Sep. 3, 2020 (JP) 2020-148269

(51) Int. Cl. H04W 76/14; H04W 72/08

(52) U.S. Cl. CPC H04W 76/14; H04W 72/087

(57) ABSTRACT

A communication unit includes a detecting unit that detects a call instruction from a user as call instruction information; a searching unit that searches for a base station that is connectible, and collects base station information related to the base station; a memory unit that is used to store the base station information; a sending unit that sends connection request information, which indicates a connection request with respect to the base station, and call request information, which indicates a call request; a receiving unit that receives a response from the base station; and a communication control unit that controls connection with the base station.

### CROSS-REFERENCE TO RELATED APPLICATIONS

This application claims priority from Japanese Application No. 2020-148269, filed on Sep. 3, 2020, the contents of which are incorporated by reference herein in its entirety.

### BACKGROUND

### 1. Technical Field

The present disclosure is related to a communication device, a communication method, and a computer program product.

### 2. Description of the Related Art

A technology is known that, according to the communication situation of base stations, changes the base stations to be registered. For example, in Japanese Patent Application Laid-open No. H9-163428, a mobile terminal is disclosed that, when a base station is in the busy state, searches for other base stations; switches to a base station in the communicable state; and performs communication.

In the case in which establishing connection with a particular base station ends in failure and hence other base stations are searched for and connection is established with a base station that is found; sometimes it requires a long period of time to establish connection. In a professional radio system configured for the police or the fire department, if establishing connection with a particular base station ends in failure, it is a requirement that connection is promptly established with another base station.

### SUMMARY

It is an object of the present disclosure to at least partially solve the problems in the conventional technology.

A communication device according to an embodiment of the present disclosure includes a detecting unit that detects a call instruction from a user as call instruction information, a searching unit that searches for a base station that is connectible, and collects base station information related to the base station that is connectible, a memory unit that is used to store the base station information, a sending unit that sends connection request information, which indicates a connection request with respect to the base station, and call request information, which indicates a call request, a receiving unit that receives a response from the base station, and a communication control unit that controls connection with the base station. The communication control unit sends, according to the call instruction information, the call request information to a first-type base station representing an already-connected base station, and when a response from the first-type base station is not receivable, identifies base station information of a second-type base station, which is different than the first-type base station, from base station information stored in the memory unit and sends the connection request information.

A communication method according to an embodiment of the present disclosure includes detecting a call instruction from a user as call instruction information, searching that includes searching for a base station that is connectible, and collecting base station information related to the base station that is connectible, storing the base station information, sending connection request information, which indicates a connection request with respect to the base station, and call request information, which indicates a call request, receiving a response from the base station, and communication-controlling that includes controlling connection with the base station. The communication-controlling includes sending, according to the call instruction information, the call request information to a first-type base station representing an already-connected base station, and when a response from the first-type base station is not receivable, identifying base station information of a second-type base station, which is different than the first-type base station, from stored base station information and sending the connection request information.

A computer program product according to an embodiment of the present disclosure having a computer readable medium including a communication program is disclosed. The communication program, when executed by a computer, causes the computer to execute a detecting function for detecting a call instruction from a user as call instruction information, a searching function for searching for a base station that is connectible, and collects base station information related to the base station that is connectible, a storing function for storing the base station information, a sending function for sending connection request information, which indicates a connection request with respect to the base station, and call request information, which indicates a call request, a receiving function for receiving a response from the base station, and a communication control function for controlling connection with the base station. The communication control function sends, according to the call instruction information, the call request information to a first-type base station representing an already-connected base station, and when a response from the first-type base station is not receivable, identifies base station information of a second-type base station, which is different than the first-type base station, from stored base station information and sends the connection request information.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram for explaining an exemplary configuration of a communication system according to an embodiment;

FIG. 2 is a block diagram illustrating an exemplary configuration of a communication device according to the embodiment;

FIG. 3 is a diagram for explaining an example of connected-base-station information;

FIG. 4 is a diagram for explaining an example of connectible-base-station information;

FIG. 5 is a sequence diagram for explaining an exemplary flow of operations performed in the communication system according to the embodiment;

FIG. 6 is a flowchart for explaining an exemplary flow of overall operations performed in the communication device according to the embodiment; and

FIG. 7 is a flowchart for explaining an exemplary flow of detailed operations performed in the communication device according to the embodiment.

### DETAILED DESCRIPTION OF THE PREFERRED EMBODIMENTS

An exemplary embodiment of the present disclosure is described below in detail with reference to the accompanying drawings. Meanwhile, the present disclosure is not limited by the embodiment described below. Moreover, when there is a plurality of embodiments, the configuration can have a combination thereof. In the following explanation, identical constituent elements are referred to by the same reference numerals, and their explanation is not given repeatedly.

### Communication System

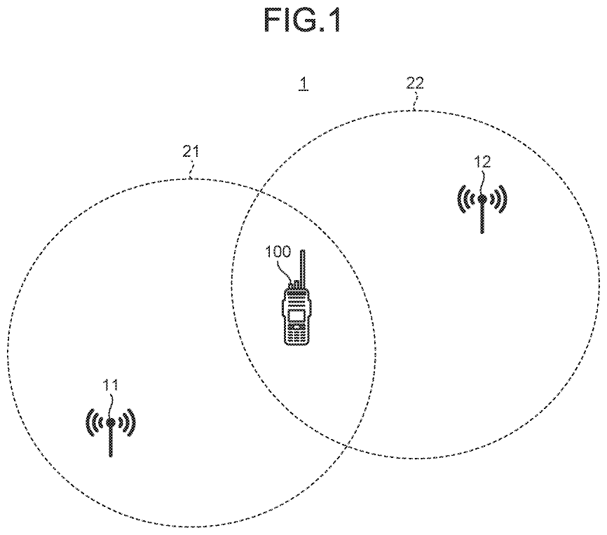

Explained below with reference to FIG. 1 is an exemplary configuration of a communication system according to the embodiment. FIG. 1 is a diagram for explaining an exemplary configuration of the communication system according to the embodiment.

As illustrated in FIG. 1, a communication system 1 includes base stations 11 and 12, and a communication device 100. The communication system 1 is, for example, a professional radio system used by the police or the fire department. Alternatively, the communication system 1 can be some other type of system.

The base stations 11 and 12 relay voice call signals transmitted from the communication device 100. The base stations 11 and 12 are installed at arbitrary locations inside or outside of buildings. A communication range 21 represents the communicable range of the base station 11. A communication range 22 represents the communicable range of the base station 12. In the following explanation, the base stations 11 and 12 are sometimes collectively referred to as base stations.

The communication device 100 is, for example, a professional radio communication device. In the example illustrated in FIG. 1, the communication device 100 is positioned within the communication range 21 as well as within the communication range 22. Thus, the communication device 100 performs communication with other communication devices either via the base station 11 or via the base station 12. For example, the communication device 100 performs voice communication with other communication devices either via the base station 11 or via the base station 12. Moreover, for example, the communication device 100 performs group communication with a plurality of other radio communication devices either via the base station 11 or via the base station 12.

### Overview of Operations Performed in Communication System

Given below is the explanation of the overview of the operations performed in the communication system 1. The communication device 100 is positioned within the communication range 21 as well as within the communication range 22; and performs a registration operation with respect to the base station 11 and registers the base station 11. After registering the base station 11, the communication device 100 searches for other connectible base stations and stores them as connectible base stations in an internal memory. As illustrated in FIG. 1, the base station 12 is a connectible base station. Alternatively, there can be a plurality of connectible base stations. When the pressing of a push-to-talk (PTT) button is detected, the communication device 100 sends a call request to the base station 11. However, the base station 11 is in the busy state, and hence the communication device 100 receives a busy notification from the base station 11. Upon receiving the busy notification, the communication device 100 automatically performs the registration operation with respect to another base station stored as a connectible base station. Thus, in the present embodiment, when a busy notification is received from a particular base station, the communication device 100 performs the registration operation with respect to another connectible base station. That enables shortening the period of time taken for establishing connection with a base station.

### Communication Device

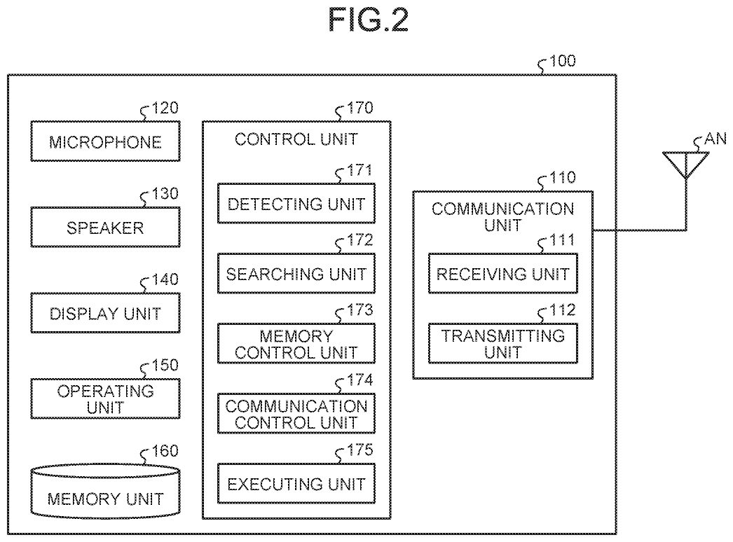

Explained below with reference to FIG. 2 is an exemplary configuration of the communication device according to the embodiment. FIG. 2 is a block diagram illustrating an exemplary configuration of the communication device according to the embodiment.

As illustrated in FIG. 2, the communication device 100 includes a communication unit 110, a microphone 120, a speaker 130, a display unit 140, an operating unit 150, a memory unit 160, and a control unit 170.

The communication unit 110 establishes connection with a base station and communicates information. Thus, the communication unit 110 communicates information with other communication devices via the communication unit 110. The communication unit 110 includes a receiving unit 111 and a transmitting unit 112.

The receiving unit 111 receives downlink signals, which are transmitted from a base station, via an antenna AN. The downlink signals received by the receiving unit 111 can include a variety of information.

The transmitting unit 112 transmits uplink signals to a base station via the antenna AN. The uplink signals transmitted by the transmitting unit 112 can include a variety of information.

The microphone 120 collects the sounds generated around the communication device 100. For example, the microphone 120 collects the voice of the user and converts it into electrical signals. Then, the microphone 120 outputs the voice in the form of electrical signals as voice call signals to the control unit 170. The speaker 130 outputs various types of sounds. For example, the speaker 130 outputs, as sounds, the sound signals received from another communication device 100.

The display unit 140 displays a variety of information. For example, the display unit 140 displays the state and the communication situation of the communication device 100. For example, the display unit 140 is configured using a display such as a liquid crystal display (LCD) or an organic electro-luminescence (organic EL) display.

The operating unit 150 receives various user operations with respect to the communication device 100. The operating unit 150 is configured using, for example, physical switches. For example, the operating unit 150 receives an operation of setting the sound volume of the sounds output from the speaker 130. The operating unit 150 includes, for example, a PTT button meant for executing the PTT operation. Meanwhile, the operating unit 150 can be configured as a touch-sensitive panel installed in the display unit 140. That is, the operating unit 150 and the display unit 140 can be configured in an integrated manner.

The memory unit 160 is configured using a semiconductor memory, a solid state drive (SSD), or a hard disk drive (HDD); and is used to store a variety of data. For example, the memory unit 160 is used to store connected-base-station information regarding the already-connected base station with respect to which the registration operation has been performed. Moreover, for example, the memory unit 160 is used to store connectible-base-station information regarding the connectible base stations with respect to which the registration operation can be performed.

The control unit 170 controls the operations of the constituent elements of the communication device 100. The control unit 170 is implemented when, for example, a central processing unit (CPU) or a micro processing unit (MPU) executes computer programs (for example, a communication program according to the present disclosure), which are stored in a memory unit (not illustrated), using a random access memory (RAM) as the work area. Alternatively, for example, the control unit 170 can be implemented using an integrated circuit such as an application specific integrated circuit (ASIC) or a field programmable gate array (FPGA). Still alternatively, the control unit 170 can be implemented as a combination of hardware and software.

The control unit 170 includes a detecting unit 171, a searching unit 172, a memory control unit 173, a communication control unit 174, and an executing unit 175.

The detecting unit 171 detects, as operation information, various operations that are input via the operating unit 150. For example, the detecting unit 171 detects a call instruction from the user as call instruction information. Herein, for example, the detecting unit 171 detects the pressing of the PTT button as the call instruction information.

The searching unit 172 searches for base stations with which the communication device 100 can establish connection. For example, based on the radio field intensity of each base station, the searching unit 172 searches for base stations with which the communication device 100 can establish connection. Thus, the searching unit 172 treats the base stations with which connection can be established as the connectible base stations. For example, the searching unit 172 collects base station information of each connectible base station. The base station information can contain, for example, the information related to the radio field intensity, the information regarding the position of the base station, and the information related to the connection track record. The connection track record contains the following information: the frequency of connection of communication devices; the connection count of communication devices within a predetermined period of time; and the information related to the connection period of communication devices within a predetermined period of time. Moreover, the base station information can also contain the information related to other base stations.

The memory control unit 173 stores a variety of information in the memory unit 160. The memory control unit 173 stores the base station information in the memory unit 160. The memory control unit 173 stores, as the connected-base-station information in the memory unit 160, the base station information regarding the base station that was registered by performing the registration operation. Moreover, the memory control unit 173 stores, as the connectible-base-station information in the memory unit 160, the base station information regarding the connectible base stations. Thus, the memory unit 160 can be configured to be able to store a plurality of sets of connectible-base-station information.

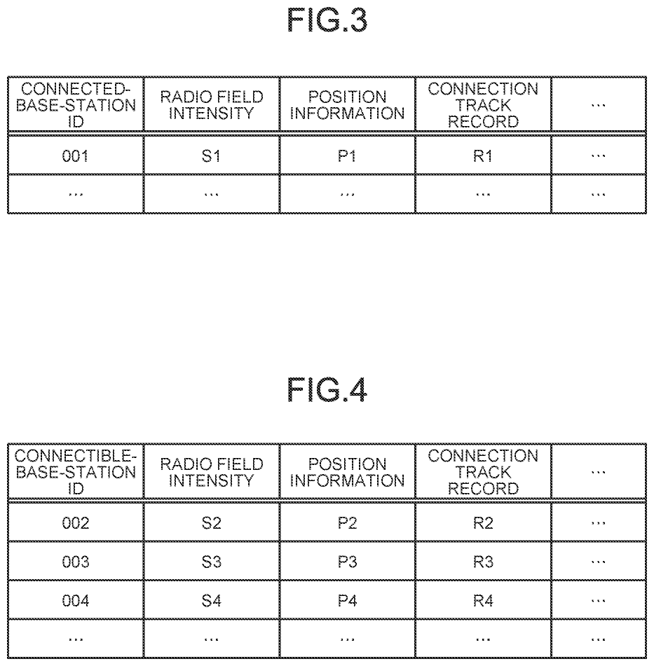

Explained below with reference to FIGS. 3 and 4 is the connected-base-station information and the connectible-base-station information. FIG. 3 is a diagram for explaining an example of the connected-base-station information.

As illustrated in FIG. 3, the connected-base-station information contains the following items: “connected-base-station ID”, “radio field intensity”, “position information”, and “connection track record”. However, the connected-base-station information can contain other items too.

The item “connected-base-station ID” represents information enabling identification of a base station. In the example illustrated in FIG. 3, “001” is illustrated as the “registered base station ID”. However, in practice, a unique identification number of the base station is specified.

The item “radio field intensity” indicates the intensity of the radio waves of the concerned base station. The item “position information” represents the information about the position of installment of the concerned base station. The item “connection track record” represents information regarding the connection track record of the concerned base station. Herein, the items “radio field intensity”, “position information” and “connection track record” are illustrated to have conceptual values such as “S1”, “P1”, and “R1”, respectively. However, in practice, specific information is mentioned in each item.

As illustrated in FIG. 4, the connectible-base-station information contains the following items: “connectible-base-station ID”, “radio field intensity”, “position information”, and “connection track record”. However, the connectible-base-station information can include other items too. Meanwhile, regarding the base station information of a connectible base station; the configuration can be such that, if connection with that base station cannot be established or if the information is not updated for a predetermined period of time, the base station information is deleted.

Returning to the explanation with reference to FIG. 2, the communication control unit 174 controls various operations related to the communication. For example, the communication control unit 174 controls the operations related to the establishment of connection between the communication device 100 and a base station. If a plurality of connectible base stations is present; then, according to the call instruction information, the communication control unit 174 sends call request information to a first-type base station representing the already-connected base station. If a response from the first-type base station is not receivable, then the communication control unit 174 identifies the base station information of a second-type base station, which is different than the first-type base station, from the base station information (the connectible-base-station information) stored in the memory unit 160, and sends connection request information to the identified second-type base station.

The executing unit 175 performs various operations. Moreover, the executing unit 175 performs a variety of determination. For example, the executing unit 175 performs the operation of outputting sounds from the speaker 130. Moreover, for example, the executing unit 175 performs the operation of displaying a video in the display unit 140.

### Operations Performed in Communication System

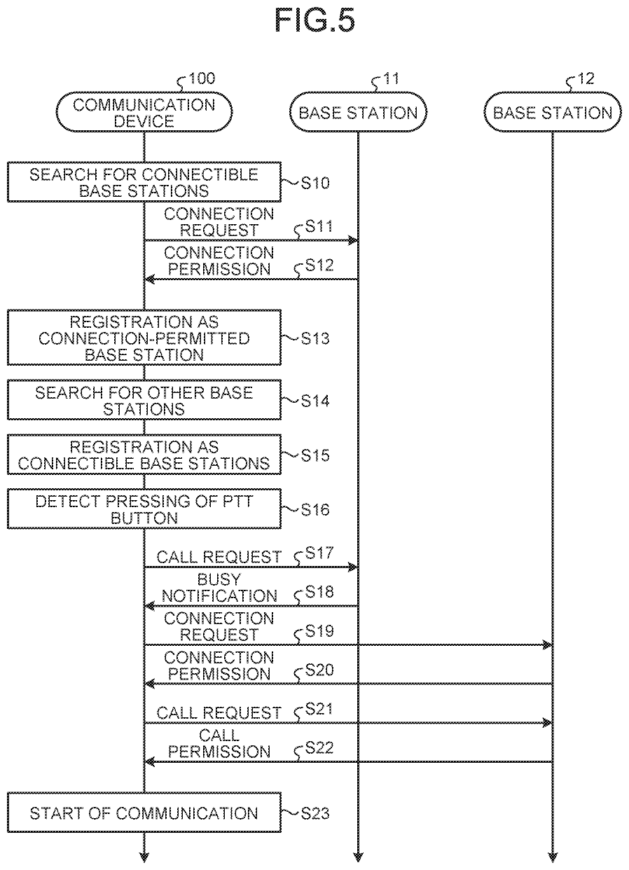

Explained below with reference to FIG. 5 are the operations performed in the communication system according to the embodiment. FIG. 5 is a sequence diagram for explaining an exemplary flow of operations performed in the communication system according to the embodiment.

In the example illustrated in FIG. 5, the operations are illustrated for the case in which the base stations 11 and 12 and the communication device 100 are involved as illustrated in FIG. 1, and the communication device 100 is positioned within the communication range of the base station 11 as well as within the communication range of the base station 12.

The communication device 100 searches for connectible base stations (Step S10). Then, the communication device 100 sends connection request information representing a connection request to the base station 11 (Step S11). In response to the connection request, the communication device 100 receives, from the base station 11, connection permission information representing a connection permission (Step S12).

Upon receiving the connection permission information from the base station 11, the communication device 100 registers the base station 11 as a connection-permitted base station (Step S13). Then, the communication device 100 searches for other connectible base stations (Step S14). Subsequently, the communication device 100 registers the other base stations, which are found, as connectible base stations (Step S15). In the example illustrated in FIG. 3, the communication device 100 registers the base station 12 as a connectible base station.

The communication device 100 detects the pressing of the PTT button (Step S16). Upon detecting the pressing of the PTT button, the communication device 100 sends call request information to the base station 11 (Step S17). However, in response to the call request information, the communication device 100 receives a busy notification from the base station 11 (Step S18). Upon receiving the busy notification from the base station 11, the communication device 100 starts a connection operation with respect to a connectible base station. Alternatively, also in the case in which there is no response from the base station 11 within a predetermined period of time, the communication device 100 can start a connection operation with respect to a connectible base station. Herein, the predetermined period of time is, for example, 10 seconds. However, that is not the only possible case.

Upon receiving the busy notification from the base station 11, the communication device 100 sends connection request information to the base station 12 that represents a connectible base station (Step S19). Then, the communication device 100 receives connection permission information from the base station 12 (Step S20).

Upon receiving the connection permission information from the base station 12, the communication device 100 sends call request information to the base station 12 (Step S21). In response to the call request information, the communication device 100 receives call permission information from the base station 12 (Step S22). Upon receiving the call permission information, the communication device starts performing communication via the base station 12 (Step S23).

### Overview of Operations Performed in Communication Device

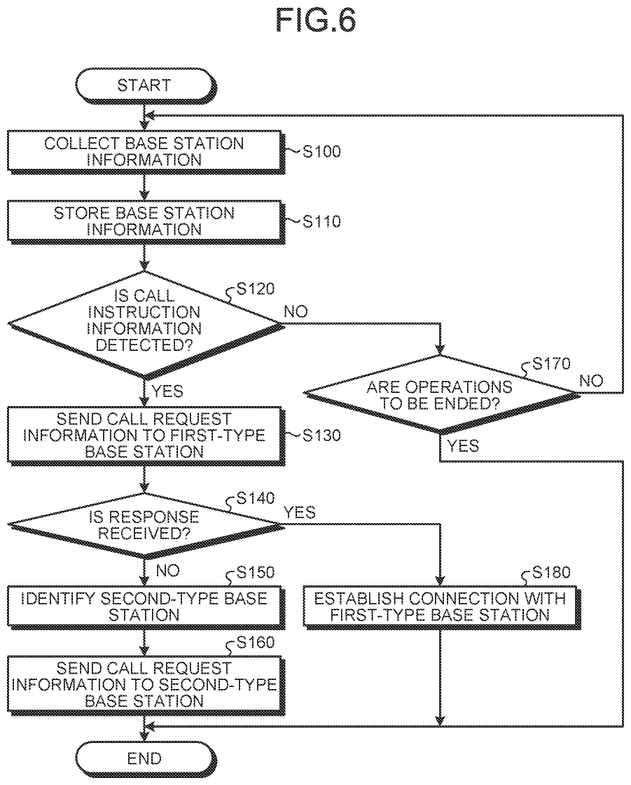

Explained below with reference to FIG. 6 is the overview of the operations performed in the communication device according to the embodiment. FIG. 6 is a flowchart for explaining an exemplary flow of overall operations performed in the communication device according to the embodiment.

The control unit 170 collects the base station information (Step S100). More particularly, the searching unit 172 collects the base station information of the connectible base stations. Then, the system control proceeds to Step S110.

Subsequently, the control unit 170 stores the base station information (Step S110). More particularly, the memory control unit 173 stores the base station information, which is collected by the searching unit 172, in the memory unit 160. Then, the system control proceeds to Step S120.

Subsequently, the control unit 170 determines whether or not call instruction information regarding a call instruction is detected (Step S120). More particularly, when the PTT button is pressed, the detecting unit 171 detects the call instruction information. If it is determined that the call instruction information is detected (Yes at Step S120), then the system control proceeds to Step S130. On the other hand, if it is determined that the call instruction information is not detected (No at Step S120), then the system control proceeds to Step S170.

If the determination at Step S120 is positive, then the control unit 170 sends call request information to the first-type base station from among a plurality of base stations (Step S130). More particularly, the communication control unit 174 sends call request information to the already-connected first-type base station. Then, the system control proceeds to Step S140.

The control unit 170 determines whether or not a response is received (Step S140). More particularly, the communication control unit 174 determines whether or not call permission information is received from the first-type base station in response to the call request information. If it is determined that there is no response (No at Step S140), then the system control proceeds to Step S150. On the other hand, if it is determined that there is a response (Yes at Step S140), then the system control proceeds to Step S180.

If the determination at Step S140 is negative, then the control unit 170 identifies a second-type base station (Step S150). More particularly, based on the base station information, the communication control unit 174 identifies a second-type base station to which connection permission information is to be sent. Then, the system control proceeds to Step S160.

The control unit 170 sends connection permission information to the second-type base station (Step S160). More particularly, the communication control unit 174 sends connection request information to the second-type base station that represents a connectible base station. That marks the end of the operations illustrated in FIG. 6.

Meanwhile, if the determination at Step S120 is negative, then the control unit 170 whether or not to end the operations (Step S170). More particularly, when an instruction to end the operations is received or when an instruction to turn off the power is received, the control unit 170 determines to end the operations. If it is determined to end the operations (Yes at Step S170), then the operations illustrated in FIG. 6 are ended. On the other hand, if it is determined not to end the operations (No at Step S170), then the system control returns to Step S100.

Meanwhile, if the determination at Step S140 is positive, then the control unit 170 establishes connection with the first-type base station (Step S180). More particularly, the communication control unit 174 starts the communication with other communication devices via the first-type base station. That marks the end of the operations illustrated in FIG. 6.

### Detailed Operations Performed in Communication Device

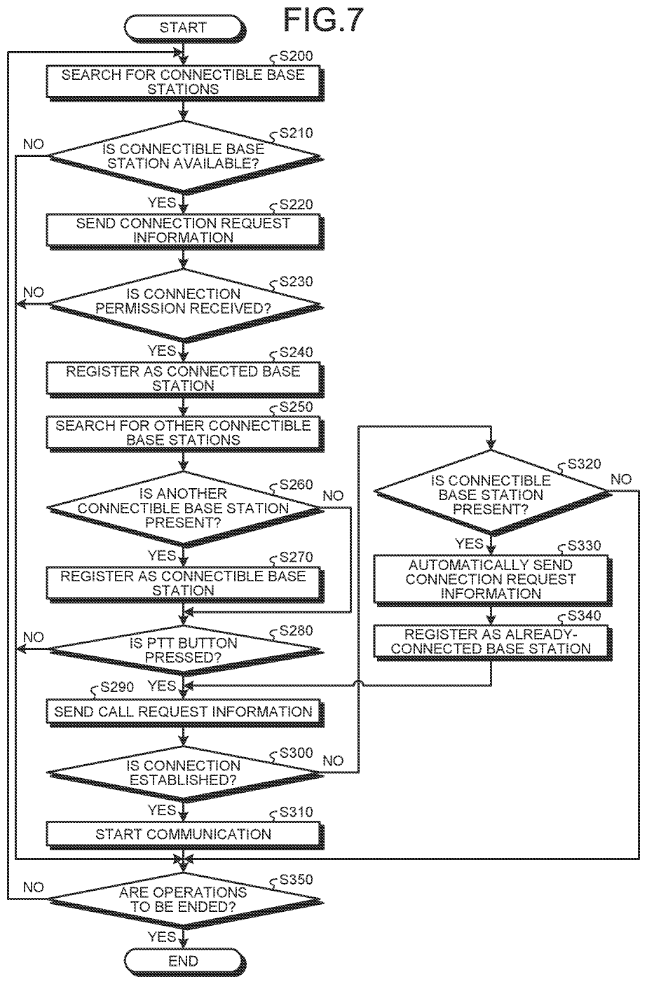

Explained below with reference to FIG. 7 is the flow of detailed operations performed in the communication device according to the embodiment. FIG. 7 is a flowchart for explaining an exemplary flow of detailed operations performed in the communication device according to the embodiment.

The control unit 170 searches for connectible base stations (Step S200). More particularly, the searching unit 172 searches for connectible base stations based on the radio field intensities. Then, the system control proceeds to Step S210.

The control unit 170 determines whether or not a connectible base station is present (Step S210). More particularly, the searching unit 172 determines that the base stations having the radio field intensities to be equal to or greater than a predetermined level are connectible base stations. If it is determined that a connectible base station is present (Yes at Step S210), then the system control proceeds to Step S220. On the other hand, if it is determined that no connectible base station is present (No at Step S210), then the system control proceeds to Step S350.

The control unit 170 sends connection request information to one of the connectible base stations (Step S220). More particularly, the communication control unit 174 sends connection request information to the base station that, from among the connectible base stations, has the highest radio field intensity. Then, the system control proceeds to Step S230.

The control unit 170 determines whether or not a connection permission is received (Step S230). More particularly, the communication control unit 174 determines whether or not connection permission information is received from the base station to which the connection request information was sent. If it is determined that the connection permission information is received (Yes at Step S230), then the system control proceeds to Step S240. On the other hand, if it is determined that the connection permission information is not received (No at Step S230), then the system control proceeds to Step S350.

If the determination at Step S230 is positive, then the control unit 170 registers the base station that sent the connection permission as the already-connected base station (Step S240). More particularly, the memory control unit 173 registers, in the memory unit 160, the base station that sent the connection permission as the already-connected base station. Then, the system control proceeds to Step S250.

The control unit 170 searches for other connectible base stations (Step S250). More particularly, the searching unit 172 performs background processing and searches for other connectible base stations. Then, the system control proceeds to Step S260.

The control unit 170 determines whether or not any other connectible base station is present (Step S260). More particularly, based on the radio field intensities, the searching unit 172 determines whether or not any other connectible base station is present. If it is determined that another connectible base station is present (Yes at Step S260), then the system control proceeds to Step S270. On the other hand, if it is determined that no other connectible base station is present (No at Step S260), then the system control proceeds to Step S280.

If the determination at Step S260 is positive, then the control unit 170 registers each other connectible base station as a connectible base station (Step S270). More particularly, the memory control unit 173 registers, in the memory unit 160, one or more connectible base stations as already-connected base stations. Then, the system control proceeds to Step S280.

When the determination at Step S260 is negative or after the operation at Step S270 is performed, the control unit 170 determines whether or not the PTT button is pressed (Step S280). More particularly, the searching unit 172 determines whether or not the user has pressed the PTT button. If it is determined that the PTT button is pressed (Yes at Step S280), then the system control proceeds to Step S290. On the other hand, if it is determined that the PTT button is not pressed (No at Step S280), then the system control proceeds to Step S350.

If the determination at Step S280 is positive, then the control unit 170 sends call request information (Step S290). More particularly, the communication control unit 174 sends call request information to the base station registered as the already-connected base station. Then, the system control proceeds to Step S300.

The control unit 170 determines whether or not connection is established (Step S300). For example, the communication control unit 174 determines whether connection is established when the call permission information is received. If a busy notification is received; then, after the elapse of a predetermined period of time (for example, 10 seconds) since sending the call request information, the communication control unit 174 determines that the connection is not established. If it is determined that connection is established (Yes at Step S300), then the system control proceeds to Step S310. On the other hand, if it is determined that connection is not established (No at Step S300), then the system control proceeds to Step S320.

If the determination at Step S300 is positive, then the control unit 170 starts to perform communication (Step S310). More particularly, the communication control unit 174 starts communicating with other communication devices. Then, the system control proceeds to Step S350.

If the determination at Step S300 is negative, then the control unit 170 determines whether or not a connectible base station is present (Step S320). More particularly, when connectible base stations are registered in the memory unit 160, the communication control unit 174 determines that a connectible base station is present. If it is determined that a connectible base station is present (Yes at Step S320), then the system control proceeds to Step S330. On the other hand, if it is determined that no connectible base station is present (No at Step S320), then the system control proceeds to Step S350.

It the determination at Step S320 is positive, then the control unit 170 automatically sends connection request information (Step S330). More particularly, the communication control unit 174 automatically sends connection request information to one of the connectible base stations. For example, if a plurality of connectible base stations is present, the communication control unit 174 sends connection request information to the base station having the highest radio field intensity. Then, the system control proceeds to Step S340.

The control unit 170 registers the base station as an already-connected base station (Step S340). More particularly, the memory control unit 173 stores, as an already-connected base station in the memory unit 160, the base station to which the call request information was sent. Then, the system control returns to Step S290.

When the determination at Steps S210, S230 S280, and S320 is negative or after the operation at Step S310 is performed, the control unit 170 determines whether or not to end the operations (Step S350). More particularly, when an instruction to end the operations is received or when an instruction to turn off the power is received, the control unit 170 determines to end the operations. If it is determined to end the operations (Yes at Step S350), then the operations illustrated in FIG. 7 are ended. On the other hand, if it is determined not to end the operations (No at Step S350), then the system control returns to Step S200.

As explained above, in the present embodiment, when connection with a base station is not established, the connection operation is automatically performed with a connectible base station. As a result, in the present embodiment, when a connectible base station is present, the connection operation is automatically started, thereby enabling shortening of the period of time taken to establish connection with a base station.

### MODIFICATION EXAMPLE

In the detailed operations performed in the communication device as illustrated in FIG. 7; prior to the operation at Step S200, a step can be added for determining whether or not an already-registered base station is available as a connectible base station and determining whether or not signals from that already-registered base station are detected. If an already-registered base station is available and if signals from that already-registered base station are detected, then the system control proceeds to Step S250. On the other hand, even if an already-registered base station is available, if signals from that already-registered base station cannot be detected, then the system control proceeds to Step S210. As a result of such a configuration, the search need not be performed at every instance of communication. That eliminates the need to search for a connectible base station at every instance of communication. Hence, it becomes possible to avoid unnecessary searches for the already-registered base stations and to reduce the processing amount.

Moreover, a step related to a timeout can be added in between Steps S300 and S320. With that, if a predetermined number of attempts are made or if a predetermined period of time has elapsed since the start of the operations, the system control proceeds to Step S350 because of the negative determination at Step S320. On the other hand, if the predetermined number of attempts are not yet made or if the predetermined period of time has not elapsed, then the system control proceeds to Step S320. As a result, the operations can be timed out based on a predetermined number of attempts and a predetermined period of time.

According to the present disclosure, it becomes possible to shorten the period of time taken to establish connection with a base station.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication device comprising:
a detecting unit that detects a call instruction from a user as call instruction information;
a searching unit that searches for a base station that is connectible, and collects base station information related to the base station that is connectible;
a memory unit that is used to store the base station information;
a sending unit that sends connection request information, which indicates a connection request with respect to the base station, and call request information, which indicates a call request;
a receiving unit that receives a response from the base station; and
a communication control unit that controls connection with the base station, wherein
the communication control unit
sends, according to the call instruction information, the call request information to a first-type base station representing an already-connected base station, and
when a response from the first-type base station is not receivable, identifies base station information of a second-type base station, which is different than the first-type base station, from base station information stored in the memory unit and sends the connection request information.

2. The communication device according to claim 1, wherein, not being able to receive a response from the first-type base station implies not being able to receive call permission information indicating a call permission within a predetermined period of time and implies reception of a busy signal from the first-type base station.

3. The communication device according to claim 1, wherein, when connection permission response information is received from the second-type base station, the communication control unit performs a connection operation by treating the second-type base station as new first-type base station and, according to the call instruction information, repeatedly performs the connection operation until communication permission response information is received from the new first-type base station.

4. A communication method comprising:
detecting a call instruction from a user as call instruction information;
searching that includes searching for a base station that is connectible, and collecting base station information related to the base station that is connectible;
storing the base station information;
sending connection request information, which indicates a connection request with respect to the base station, and call request information, which indicates a call request;
receiving a response from the base station; and
communication-controlling that includes controlling connection with the base station, wherein
the communication-controlling includes
sending, according to the call instruction information, the call request information to a first-type base station representing an already-connected base station, and
when a response from the first-type base station is not receivable, identifying base station information of a second-type base station, which is different than the first-type base station, from stored base station information and sending the connection request information.

5. A computer program product having a computer readable medium including a communication program, wherein the communication program, when executed by a computer, causes the computer to execute:
a detecting function for detecting a call instruction from a user as call instruction information;
a searching function for searching for a base station that is connectible, and collects base station information related to the base station that is connectible;
a storing function for storing the base station information;
a sending function for sending connection request information, which indicates a connection request with respect to the base station, and call request information, which indicates a call request;
a receiving function for receiving a response from the base station; and
a communication control function for controlling connection with the base station, wherein
the communication control function
sends, according to the call instruction information, the call request information to a first-type base station representing an already-connected base station, and
when a response from the first-type base station is not receivable, identifies base station information of a second-type base station, which is different than the first-type base station, from stored base station information and sends the connection request information.
